(19) United States
(12) Patent Application Publication
(10) Pub. No.: US 2012/0311647 A1
(43) Pub. Date: Dec. 6, 2012

(54) SYSTEM AND METHOD FOR TRIGGER BASED SWITCHING BETWEEN MULTIPLE VIDEO STREAMS ON INTERNET PROTOCOL (IP) AT CLIENT LEVEL

(75) Inventors: Krishna Kumar Sharma, New Delhi (IN); Kawaljit Singh Bedi, New Delhi (IN); Vikram Chandra, New Delhi (IN); Vikas Panwar, New Delhi (IN); Saurabh Pant, New Delhi (IN)

(73) Assignee: NDTV CONVERGENCE LTD., New Delhi (IN)

(21) Appl. No.: 13/505,995

(22) PCT Filed: Nov. 4, 2010
(86) PCT No.: PCT/IN10/00728

§ 371 Date: Aug. 22, 2012

(30) Foreign Application Priority Data
Nov. 4, 2009 (IN) 2263/DEL/2009

(51) Int. Cl. H04N 21/25

(52) U.S. Cl. 725/94

(57) ABSTRACT

The present invention provides a system and a scalable method for switching automatically between multiple streams of multimedia data, preferably between live and on-demand streams and for automatically switching between a mix of live streams and on-demand/static streams at the client device. A client application polls the URL (Uniform Resource Locator) to detect changes made by a service provider and in turn makes the switch between streams.

### FIELD OF TECHNOLOGY

The instant invention generally relates to a system and method for switching between multiple multimedia streams and more particularly relates to a system and method for performing said switching automatically at a client device and in dynamic synchronization with a telecommunication device's broadcast of live streams and on demand-streams/static streams based on predefined trigger(s).

### BACKGROUND

The conventional methods & systems of the prior art to switch between a live streaming multimedia data such as video stream and an on-demand multimedia streams of videos (like advertisements) in a network such as world wide web, rely on switching of both said multimedia/video streams to be switched at the source level. Here, a system that is sending out a web cast switches the live stream with the on demand stream at the source. In a disparate workflow where said switching of the streams is required at client side (e.g. at a video player level), there is no feasible and scalable technical scheme to achieve this.

US Patent application no, US 2002/0194592 A1, Tsuchida et al describes a system and method for displaying substitute content. However, here the method of switching is either user initiated and more importantly does not suggest the technical scheme of automatically detecting the ‘break’ in streams. The present invention pertains to the novel and technical process of how breaks are detected and switched for the user.

US patent application US 2006/0242664 A1, Kikkawa et al. proposes an apparatus and method to enable control processing for live streaming distribution of tuner received content from a server to a client. However, in this application, URL returns a list of available channels for the user who can choose which one to watch. The technical scheme of the present invention automatically polls the URL to check if switching from live feed (single channel) to an on-demand feed is required and (vice versa).

Similarly, U.S. patent application Ser. No. 6,950,623 B2, Brown at al, attempts to describe a method and system for dynamically serving in-stream advertisements. As per this application, ads are inserted dynamically into a stream of audio or video upon detection of an e.g. an advertisement event. However, no technical scheme whatsoever is suggested to implement the same as clearly and unambiguously as described in the present invention.

Hence, none of the related art describes or suggests automatic and/or trigger based detection of predetermined events, so as to allow switching between a live stream and an on-demand stream at client level i.e. at client device. Also none of the related art describes or fairly suggests that the client device in fact automatically polls the URL (Uniform Resource Locator) to detect appropriate change in multimedia streams such as video streams by service provider and that the client device in turn dynamically makes the switch between streams.

### SUMMARY

An embodiment of the present invention provides a system and a scalable method for switching automatically between multiple streams of multimedia data, preferably between live and on-demand streams.

In another embodiment the present invention provides a system and a scalable method for automatically switching between a mix of live streams and on-demand/static streams.

In another embodiment said automatic switching between multiple streams is done at the client device.

In yet another embodiment, a client application polls the URL (Uniform Resource Locator) to detect changes made by a service provider and in turn makes the switch between streams.

### BRIEF DESCRIPTION OF THE DRAWINGS

FIG. 1 illustrates an overview of the exemplary architecture used to implement the objectives of the present invention.

### DETAILED DESCRIPTION

The various features of the preferred embodiment of present invention together with its objects and advantages thereof may be best understood by reference to the description taken in conjunction with the accompanying schematic drawing(s) of the architecture.

The present invention makes considerable use of GPIB (General purpose interface bus) that is specifically configured to connect computing devices, peripherals etc. so that data and control information could pass between them. GPI triggers are physical connections between two pieces of equipments. GPI triggers allow one device to remotely start another device.

Some exemplary applications for GPI triggers include firing off an external digital video effects generator from a switch, creating a remote “clicker” for a weatherperson to use during a broadcast, or working with motion control etc.

Also, the exemplary client device of the present invention comprises of a plurality of processors configured to meet the objectives of the present invention.

The client device of the present invention could be any portable, hand held wireless device including but not limited to video/audio player that are configured to carry out above mentioned and more objectives of the present invention.

Live multimedia streams allows a user to broadcast or webcast a live event in real time on the Internet e.g. live telecast of news, sports etc. On-demand multimedia streams, on the other hand include broadcasting of static or recorded events e.g. broadcasting of advertisements as commercial breaks between different segments of live events.

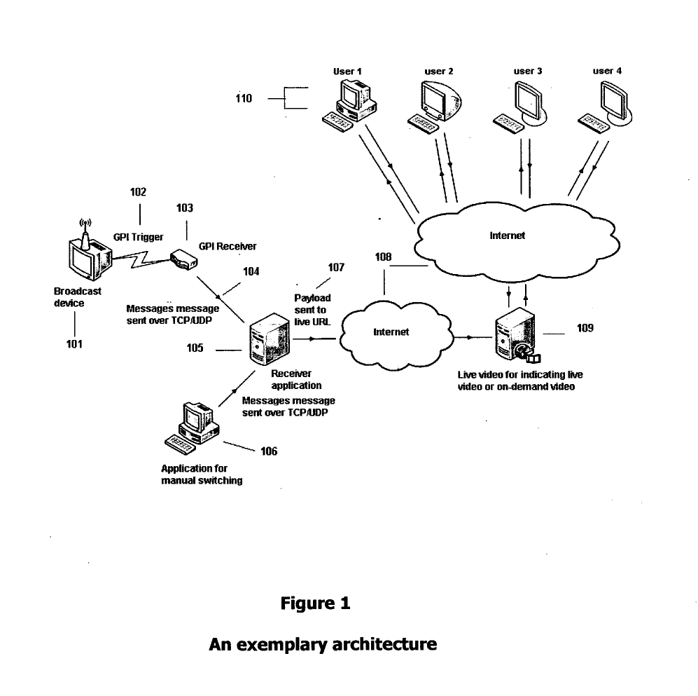

Now referring to FIG. 1, to explain an exemplary infrastructure used to achieve objectives of the present invention in a distributed network environment.

A broadcast switch [101] sends a GPI [General Purpose Interface] trigger [102] to a GPI card [103]. GPI card [103] of the present invention is configured to parse the signal, determine the channel to be used, and send a preconfigured message [104] based on well known TCP/UDP protocols to a predetermined IP address via said channels, with a socket connection on a particular port [105].

In case a manual switching is required, said configured TCP/UDP message is sent manually by a server application [106] via a socket on the same port.

In both the cases, configured application at the client device of the present invention listens to TCP/UDP message on the particular IP (Internet Protocol address) and port and processes it. Based on configuration, the application creates a payload [107] which determines the multimedia stream that needs to be pulled, and the application subsequently updates a live URL (Uniform Resource Locator)/resource identifier available on the network [108].

The client application [109] executing on a processor of a client device pings the live URL after every predetermined ‘x’ (i.e. after an optimized interval) intervals to read payload. Based on the content of payload, the stream to be played is determined i.e. whether to play an on-demand stream representing such as an advertisement at client device or to play a live multimedia/video stream [110].

Also, as a person ordinary skilled in the art would appreciate that the same technical scheme as described and claimed in the present invention is equally applicable to switch between a mix of live streams and on-demand streams.

The present invention is not intended to be restricted to any particular form or arrangement, or any specific embodiment, or any specific use, disclosed herein, since the same may be modified in various particulars or relations without departing from the spirit or scope of the claimed invention herein shown and described of which the apparatus or method shown is intended only for illustration and disclosure of an operative embodiment and not to show all of the various forms or modifications in which this invention might be embodied or operated.

1-18. (canceled)

19. A system for switching between a plurality of multimedia streams representing a first set of live multimedia streams and a second set of on-demand multimedia streams, said system comprising
a broadcasting device configured to send a plurality of electronic stimulus/triggers to a processing unit, said processing unit configured to parse received stimulus as signals, determine a first channel from a plurality of channels to send predefined messages to a predetermined and configured device accessible by a configured address;
a client device comprising a processor configured to execute
a client utility to
dynamically recognize and process said predefined messages via said configurable addresses,
create a payload comprising information configured to
determine multimedia stream to be switched and to update a resource identifier with said payload information, wherein the client device is configured to check availability of said resource identifier to interpret said payload after predetermined intervals and determine the multimedia stream to be played based on payload information of said resource identifier.

20. A system for switching between a plurality of multimedia streams as claimed in claim 19, wherein broadcasting device sends a GPI [General Purpose Interface] trigger to said processing unit.

21. A system for switching between a plurality of multimedia streams as claimed in claims 19 and 20, wherein said broadcasting device is a broadcast switch.

22. A system for switching between a plurality of multimedia streams as claimed in claim 19, wherein said processing unit is a GPI [General Purpose Interface] card.

23. A system for switching between a plurality of multimedia streams as claimed in claim 19, wherein said switching is manual and preconfigured messages are sent manually by a server utility via a socket present on the port of said client device.

24. A system for switching between a plurality of multimedia streams as claimed in claim 19, wherein said resource identifier is a Uniform Resource Locator.

25. A system for switching between a plurality of multimedia streams as claimed in claim 19, wherein said client device is a video player and/or audio player.

26. A system for switching between a plurality of multimedia streams as claimed in claim 19, wherein said first set of multimedia streams and second set of multimedia streams comprise of a mix of live multimedia streams and on-demand multimedia streams.

27. A system for switching between a plurality of multimedia streams as claimed in claim 19, wherein said client device is a wireless device.

28. A method for switching between a plurality of multimedia streams representing a first set of live multimedia streams and a second set of on-demand multimedia streams said method comprising the steps of
sending a plurality of electronic stimulus/triggers towards a processing unit, said processing unit configured for parsing received stimulus as signals, determining a first channel from a plurality of channels for sending predefined messages towards a predetermined and configured device accessible by a configured address, by a broadcasting device;
dynamically recognizing and processing said predefined messages via said
configurable addresses by a client utility executing on a configured processor of a client device and creating a payload comprising information configured for determining multimedia stream to be switched and for updating a resource identifier with said payload information by said client utility of said client device, wherein the processor of the client device is configured for checking availability of said resource identifier for interpreting said payload after predetermined intervals and for determining the multimedia stream to be played based on payload information of said resource identifier.

29. A method for switching between a plurality of multimedia streams as claimed in claim 28, wherein broadcasting device is configured for sending a GPI [General Purpose Interface] trigger towards said processing unit.

30. A method for switching between a plurality of multimedia streams as claimed in claims 28 and 29, wherein said broadcasting device is a broadcast switch.

31. A method for switching between a plurality of multimedia streams as claimed in claim 28, wherein said processing unit is a GPI [General Purpose Interface] card.

32. A method for switching between a plurality of multimedia streams as claimed in claim 28, wherein said switching is manual and preconfigured messages are sent manually by a server utility via a socket present on a predetermined port of said client device.

33. A method for switching between a plurality of multimedia streams as claimed in claim 28, wherein said resource identifier is a Uniform Resource Locator.

34. A method for switching between a plurality of multimedia streams as claimed in claim 28, wherein said client device is a video player and/or audio player.

35. A method for switching between a plurality of multimedia streams as claimed in claim 28, wherein said first set of multimedia streams and second set of multimedia streams comprise of a mix of live multimedia streams and on-demand multimedia streams.

36. A method for switching between a plurality of multimedia streams as claimed in claim 28, wherein said client device is a wireless device.
